(19) United States
(12) Patent Application Publication
(10) Pub. No.: US 2025/0249875 A1
(43) Pub. Date: Aug. 7, 2025

(54) BRAKING CONTROL DEVICE

(71) Applicants: TOYOTA JIDOSHA KABUSHIKI KAISHA, Aichi-ken (JP); ADVICS CO., LTD., AICHI-KEN (JP); J-QuAD DYNAMICS Inc., Tokyo (JP)

(72) Inventors: Yoshinori MAEDA, Aichi-gun (JP); Yosuke HASHIMOTO, Tokyo (JP)

(21) Appl. No.: 19/001,412

(22) Filed: Dec. 25, 2024

(30) Foreign Application Priority Data
Feb. 2, 2024 (JP) 2024-014687

(51) Int. Cl. B60T 8/1755; B60T 8/171

(52) U.S. Cl. CPC B60T 8/17551; B60T 8/171; B60T 2220/03

(57) ABSTRACT

In a braking control device, a control unit is configured to control the yaw moment and the roll moment by independently controlling a braking force to be applied to each of the wheels of a vehicle by a braking device from the time an intervention condition is satisfied to the time an intervention end condition is satisfied while the vehicle turns. A change unit is configured to perform at least one of changing the intervention condition to be more easily satisfied and changing the intervention end condition to be less easily satisfied when the braking device is in a low-temperature state than when the braking device is in a non-low-temperature state.

### CROSS-REFERENCE TO RELATED APPLICATION

This application claims priority to Japanese Patent Application No. 2024-014687 filed on Feb. 2, 2024. The disclosure of the above-identified application, including the specification, drawings, and claims, is incorporated by reference herein in its entirety.

### BACKGROUND

### 1. Technical Field

The present disclosure relates to a braking control device.

### 2. Description of Related Art

Japanese Patent Application Publication No. 2020-199814 (JP 2020-199814 A) discloses a vehicle braking control device that can prevent a decrease in braking performance while the friction brake is cold. In this technique, when a request to decelerate a vehicle is made by the driver and when it is determined that the estimated temperature of the friction brake is equal to or lower than a setting value or when it is determined that the friction brake has not been used for a predetermined period of time, the friction brake is operated more strongly.

### SUMMARY

A technique is known that independently controls braking force, applied to each of the wheels of a vehicle, to control the yaw moment and the roll moment when the vehicle turns. In this technique, since the sum of the braking forces of the wheels, when converted into a longitudinal acceleration, is extremely small, the occupants are practically unable to recognize that braking force is being applied while the vehicle turns. In this technique, when the braking device is in the low-temperature state, desired control performance may not be obtained since the braking force decreases due to a decrease in the friction coefficient of the brake pads and a desired hydraulic responsiveness cannot be obtained due to an increase in the viscosity of the brake fluid. Therefore, when the braking device is in the low-temperature state, it is desired to quickly raise the temperature of the brake pads, etc.

However, when the braking force is increased in a low temperature state to quickly raise temperature as in the technology described in JP 2020-199814 A, the inventors have recognized that, when the braking force and hydraulic responsiveness increase in response to a temperature rise in the brake pads, etc., the occupants may easily notice that the braking force is being applied while the vehicle turns with the result that the occupants may feel uncomfortable. It is difficult to increase the braking force to such an extent that makes it difficult for the occupants to recognize that the braking force is being applied while ensuring robustness.

It is an object of the present disclosure to provide a technique, for use in a braking control device that controls braking force applied to each of the wheels to control the vehicle attitude, that can quickly achieve a desired control without causing the occupants to feel uncomfortable when the braking device is in a low temperature state.

A first aspect of the present disclosure relates to a braking control device including a control unit and a change unit. The control unit is configured to control the yaw moment and the roll moment by independently controlling a braking force to be applied to each of the wheels of the vehicle by a braking device from the time an intervention condition is satisfied to the time an intervention end condition is satisfied while a vehicle turns. The change unit is configured to perform at least one of changing the intervention condition to be more easily satisfied and changing the intervention end condition to be less easily satisfied when the braking device is in the low-temperature state than when the braking device is in the non-low-temperature state.

According to the present disclosure, the braking control device that controls the braking force to be applied to each of the wheels to control the vehicle attitude can quickly perform desired control without causing the occupants to feel uncomfortable when the braking device is in a low-temperature state.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a vehicle in an embodiment;

FIG. 2 is a diagram showing a functional configuration of a braking control device shown in FIG. 1;

FIG. 3 is a diagram showing the relationship between a first angular speed threshold value and a vehicle speed before and after a change;

FIG. 4 is a diagram showing the relationship between the friction coefficient of a brake pads and the temperature of a brake fluid;

FIG. 5 is a flowchart showing the processing for changing the intervention condition of the braking control device shown in FIG. 2; and

FIG. 6 is a flowchart showing another processing for changing the intervention condition of the braking control device shown in FIG. 2.

### DETAILED DESCRIPTION OF EMBODIMENTS

An embodiment of the present disclosure will be described in detail below with reference to the drawings. In the description, the same components are denoted by the same reference numerals and duplicated description will be omitted as appropriate.

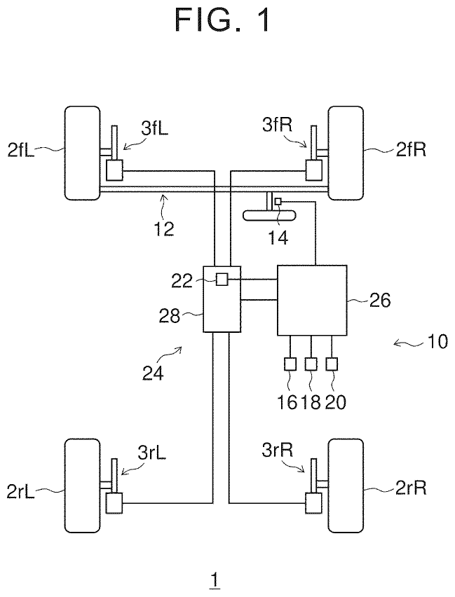

FIG. 1 shows a schematic configuration of a vehicle 1 in the embodiment. The vehicle 1 includes a front left wheel 2fL, a front right wheel 2fR, a rear left wheel 2rL, a rear right wheel 2rR, and a vehicle control system 10. In the description below, the front left wheel 2fL, front right wheel 2fR, rear left wheel 2rL, and rear right wheel 2rR will be collectively referred to as wheels 2 unless there is a particular need to distinguish between them.

The vehicle 1 may be a vehicle that generates vehicle driving force only by an internal combustion engine or may be an electrified vehicle. The electrified vehicle may be a hybrid electric vehicle (HEV) that generates vehicle driving force by an internal combustion engine and a motor or may be a battery electric vehicle (BEV) or a fuel cell electric vehicle (FCEV) that generates vehicle driving force only by a motor.

The vehicle control system 10 is capable of independently controlling the braking force of each of the four wheels of the vehicle 1 based on an driver's input. The driver's input includes the driver's accelerator operation, braking operation, and steering wheel operation.

The vehicle control system 10 includes a steering device 12, a steering angle sensor 14, an accelerator pedal sensor 16, a brake pedal sensor 18, a vehicle speed sensor 20, a brake fluid temperature sensor 22, a braking device 24, and a braking control device 26.

The steering device 12 steers the steered wheels, the front left wheel 2fL and the front right wheel 2fR, in response to the operation of the steering wheel of the vehicle 1 by the driver.

The steering angle sensor 14 detects the steering wheel operation amount of the vehicle 1 by the driver and supplies the detected operation amount to the braking control device 26. The steering wheel operation amount is the steering angle.

The accelerator pedal sensor 16, provided on the accelerator pedal of the vehicle 1, detects the accelerator pedal operation amount by the driver and supplies the detected operation amount to the braking control device 26. The accelerator pedal operation amount is, for example, the amount of accelerator pedal depression by the driver.

The brake pedal sensor 18, provided on the brake pedal of the vehicle 1, detects the brake pedal operation amount by the driver and supplies the detected operation amount to the braking control device 26. The brake pedal operation amount is, for example, the amount of brake pedal depression by the driver.

The vehicle speed sensor 20 detects the vehicle speed of the vehicle 1 and supplies the detected vehicle speed to the braking control device 26.

The braking device 24 has a front left disc brake unit 3fL, a front right disc brake unit 3fR, a rear left disc brake unit 3rL, a rear right disc brake unit 3rR, and a brake actuator 28. As the braking device 24, a known configuration can be used.

In the description below, the front left disc brake unit 3fL, front right disc brake unit 3fR, rear left disc brake unit 3rL, and rear right disc brake unit 3rR will be collectively referred to as a disc brake unit 3 unless there is a particular need to distinguish between them.

The brake actuator 28 applies a braking force corresponding to the brake pedal depression amount to each of the wheels 2 of the vehicle 1. The brake actuator 28, under the control of a control signal supplied from the braking control device 26, can apply a braking force independently to each of the wheels 2 of the vehicle 1. The brake actuator 28 is connected to each of the disc brake units 3 by an individual brake pipe for independently adjusting the hydraulic pressure of the brake fluid supplied to each of the disc brake units 3. The brake pipe may be the so-called front-rear arrangement of dual pipes or the X-type arrangement of dual pipes.

Each disc brake unit 3 has a caliper, a brake disc, and brake pads (not shown). A wheel cylinder (not shown), built into the caliper, is connected to the brake actuator 28 via a brake pipe and, through the hydraulic pressure of the brake fluid supplied from the brake actuator 28, presses the brake pads against the brake disc that rotates together with the wheels 2, thereby applying a braking force to the wheels 2.

The brake fluid temperature sensor 22, provided in the brake actuator 28, detects the temperature of the brake fluid and supplies the detected temperature to the braking control device 26.

The braking control device 26 individually controls the braking force to be applied to each of the wheels 2 by the braking device 24, for example, while the vehicle 1 turns, based on the detected operation amount, and controls the yaw moment and roll moment of the vehicle 1 to control the attitude of the vehicle 1. The braking control device 26 can be configured with an electronic control unit (ECU).

The vehicle control system 10 may include at least one of a drive actuator that controls the vehicle driving force of the vehicle 1, an actuator such as an active suspension that controls the vertical force of the vehicle 1, and a steering actuator that controls the lateral force of the vehicle 1. In this case, the braking control device 26 may also control these actuators based on the detected operation amount and may function as a vehicle control device that controls the attitude of the vehicle 1.

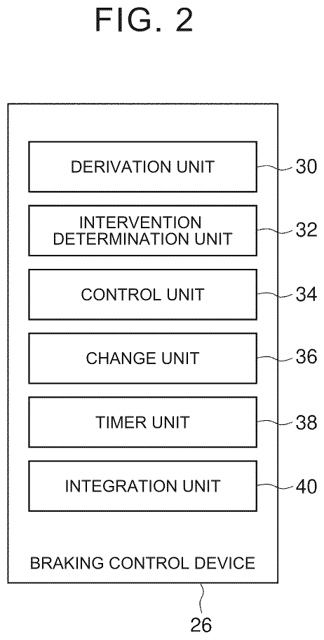

FIG. 2 shows a functional configuration of the braking control device 26 shown in FIG. 1. The braking control device 26 has a derivation unit 30, an intervention determination unit 32, a control unit 34, a change unit 36, a timer unit 38, and an integration unit 40.

The braking control device 26 can be configured in hardware by the CPU, memory, and other LSIs of a computer and, in software, by programs loaded into memory. FIG. 2 shows the functional blocks implemented through cooperation between hardware and software. Therefore, it will be understood by those skilled in the art that these functional blocks can be implemented in various forms by hardware only, software only, or a combination of hardware and software.

The derivation unit 30 periodically derives the longitudinal force at the position of each of the wheels 2 based on the driver's operational input and periodically supplies the derived longitudinal force to the control unit 34. The longitudinal force of each of the wheels 2, which is the target longitudinal force, corresponds to the braking force to be generated at each disc brake unit 3.

For example, the derivation unit 30 periodically derives the six-component force at center of gravity, based on the detected accelerator pedal operation amount, detected brake pedal operation amount, detected steering angle, and the predetermined vehicle motion model. The six-component force at center of gravity includes the longitudinal force, lateral force, vertical force, roll moment, pitch moment, and yaw moment acting on the center of gravity of the above-spring structure of the vehicle 1. The derivation unit 30 periodically derives the longitudinal force at the position of each of the wheels 2 based on the derived six-component force at center of gravity.

Since various known techniques can be used to derive the longitudinal force of each of the wheels 2 based on the driver's operational input, further detailed description will be omitted. For example, the longitudinal force may be derived using the technique described, for example, in Japanese Patent Application Publication No. 2022-21715 (JP 2022-21715 A).

The intervention determination unit 32 periodically determines whether the intervention condition is satisfied and supplies the determination result to the control unit 34. The intervention condition includes that the steering angular speed is equal to or higher than the first angular speed threshold value. For example, the higher the vehicle speed, the smaller the first angular speed threshold value.

When the intervention condition is satisfied, the intervention determination unit 32 periodically determines whether the intervention end condition is satisfied and supplies the determination result to the control unit 34. The intervention end condition includes that the steering angular speed is lower than the second angular speed threshold value or that the elapsed time since the intervention condition was satisfied reaches a predetermined end time.

The second angular speed threshold value is smaller than the first angular speed threshold value. That is, the threshold values for the steering angular speed have hysteresis. For example, the second angular speed threshold value may be smaller than the first angular speed threshold value by a certain value. The certain value can be appropriately determined through experiments or simulations.

The intervention determination unit 32 has a control timer (not shown). The control timer starts counting the elapsed time when the intervention condition is satisfied. The intervention determination unit 32 determines that the intervention end condition is satisfied when the steering angular speed becomes lower than the second angular speed threshold value before the elapsed time reaches the predetermined end time. The intervention determination unit 32 determines that the intervention end condition is satisfied also when the elapsed time reaches the end time before the steering angular speed becomes lower than the second angular speed threshold value. The end time can be appropriately determined through experiments or simulations.

The intervention condition may include that the steering angular speed is equal to or higher than the first angular speed threshold value, that the vehicle speed is equal to or higher than the first vehicle speed threshold value, and that the steering angle is equal to or larger than the first steering angle threshold value. In this case, the intervention end condition may include that the steering angular speed is lower than the second angular speed threshold value, that the vehicle speed is lower than the second vehicle speed threshold value, that the steering angle is smaller than the second steering angle threshold value, or that the elapsed time since the intervention condition was satisfied reaches the end time. The second vehicle speed threshold value may be smaller than the first vehicle speed threshold value. The second steering angle threshold value may be smaller than the first steering angle threshold value. That is, the threshold values for the vehicle speed and the threshold values for the steering angle also have hysteresis. As the intervention condition and the intervention end condition, various other known conditions may be used.

The control unit 34 controls the yaw moment and the roll moment by independently controlling the braking force to be applied to each of the wheels 2 by the braking device 24 from the time the intervention condition is satisfied to the time the intervention end condition is satisfied while the vehicle 1 turns, based on the longitudinal force of each of the wheels 2 periodically supplied from the derivation unit 30.

The control unit 34 sends the control command to the brake actuator 28 based on the longitudinal force of each of the wheels 2, derived by the derivation unit 30, to implement vehicle control according to the driver input. For example, the control unit 34 converts the derived longitudinal force of each of the wheels 2 into the control command for the brake actuator 28.

As described above, when the driver operates the steering wheel to turn the vehicle 1, the braking control device 26 automatically controls the braking force to be applied to each of the wheels 2. This control allows the yaw moment to approach the target yaw moment derived by the derivation unit 30, and the roll moment to approach the target roll moment derived by the derivation unit 30, thus controlling the attitude of the vehicle 1 during turning.

The change unit 36 periodically determines whether the braking device 24 is in the low-temperature state, based on the elapsed time since the vehicle 1 became drivable, the temperature of the brake fluid of the braking device 24, and the integrated value of the heat energy in the brake pads of the braking device 24 since the vehicle 1 became drivable. Detailed conditions for the determination will be described later.

The change unit 36 performs at least one of changing the intervention condition to be more easily satisfied and changing the intervention end condition to be less easily satisfied when it is determined that the braking device 24 is in the low-temperature state than when it is determined that the braking device 24 is in the non-low-temperature state.

Changing the intervention condition to be more easily satisfied includes changing the first angular speed threshold value to a smaller value.

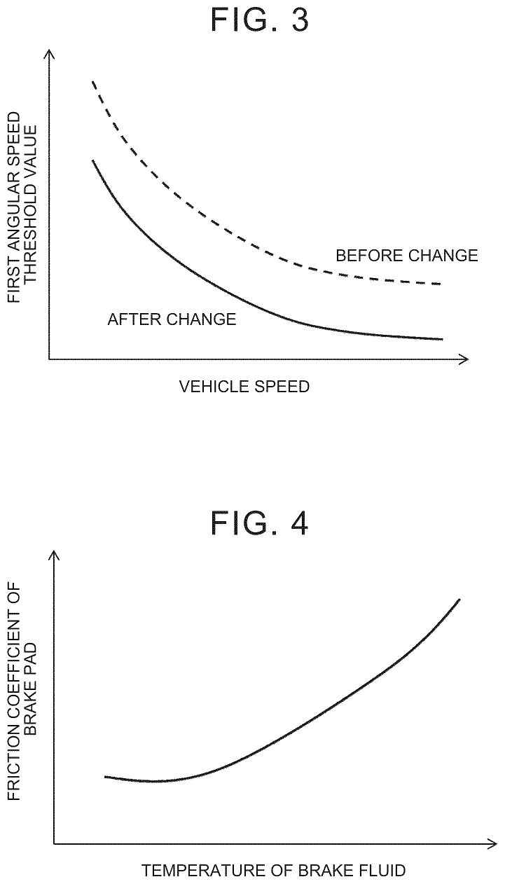

FIG. 3 shows the relationship between the first angular speed threshold value and the vehicle speed before and after a change. The first angular speed threshold value before the change is shown by the dashed line, and the first angular speed threshold value after the change by the solid line. As shown in FIG. 3, before and after the change, the lower the vehicle speed is, the larger the first angular speed threshold value is, and the higher the vehicle speed is, the smaller the first angular speed threshold value is. The first angular speed threshold value before the change is used when the braking device 24 is in the non-low-temperature state. The first angular speed threshold value after the change is used when the braking device 24 is in the low-temperature state, and is smaller than the first angular speed threshold value before the change.

The relationship between the first angular speed threshold value and the vehicle speed before and after the change is stored in advance in a storage unit (not shown). The relationship between the first angular speed threshold value and the vehicle speed before and after the change can be appropriately determined through experiments or simulations. For example, the first angular speed threshold value after the change may be a value obtained by subtracting a predetermined value from the first angular speed threshold value before the change.

Changing the intervention end condition to be less easily satisfied includes at least one of changing the second angular speed threshold value to a smaller value and changing the end time count value of the control timer to a larger value.

The second angular speed threshold value after the change is smaller than the first angular speed threshold value after the change. In other words, the threshold values for the steering angular speed have hysteresis also after the change. For example, the second angular speed threshold value after the change may be smaller than the first angular speed threshold value after the change by a certain value. When the second angular speed threshold value before the change is smaller than the first angular speed threshold value after the change, it is not necessary to change the second angular speed threshold value.

It can also be said that the change unit 36 changes at least one of the intervention condition and the intervention end condition so that the execution time of the braking force control during a certain period of time while the vehicle turns becomes longer when it is determined that the braking device 24 is in the low-temperature state than when it is determined that the braking device 24 is in the non-low-temperature state.

When the braking device 24 changes from the low-temperature state to the non-low-temperature state, the change unit 36 restores the changed condition, either the intervention condition or the intervention end condition whichever has been changed, to the original.

Changing the intervention condition to be more easily satisfied when the braking device 24 is in the low-temperature state than when the braking device 24 is in the non-low-temperature state in this way allows the control unit 34 to start controlling the braking force more easily, increasing the frequency of intervention in the control of the braking force. This in turn makes it possible to quickly raise the temperature of the brake pads and the brake fluid and to quickly increase the friction coefficient of the brake pads and improve the hydraulic responsiveness of the brake fluid. Therefore, desired vehicle control can be executed sooner.

In addition, changing the intervention end condition to be less easily satisfied when the braking device 24 is in the low-temperature state than when the braking device 24 is in the non-low-temperature state is likely to increase the control time of the braking force by the control unit 34. This also makes it possible to quickly raise the temperature of the brake pads and the brake fluid, allowing desired vehicle control to be executed sooner.

When the braking device 24 is in the low-temperature state, changing the intervention condition to be more easily satisfied and changing the intervention end condition to be less easily satisfied make it possible to quickly raise the temperature of the brake pads and the brake fluid.

Since the target longitudinal force derived by the derivation unit 30, i.e., the target braking force, is not changed even in the low-temperature state, the occupants are less likely to recognize that braking force is being applied by the braking control device 26 while the vehicle 1 turns and, therefore, the occupants are less likely to feel uncomfortable. This is because, even if the braking force increases in response to an increase in the temperature of the brake pads, the target braking force is the same as the value assumed in the non-low-temperature state.

Next, the following describes how to determine whether the braking device 24 is in the low-temperature state. The timer unit 38 counts the elapsed time Ts since the vehicle 1 entered the drivable state, and supplies the elapsed time Ts to the change unit 36.

For the vehicle 1 that generates vehicle driving force only by an internal combustion engine, that the vehicle 1 has entered the drivable state means that the internal combustion engine has started. For an electrified vehicle, that the vehicle 1 has entered the drivable state corresponds to the state in which the ignition switch has been turned from off to on and the driving system (not shown) has changed from the stopped state to the started state. The ignition switch is also called a start switch. The started state is also called a Ready-ON state.

The integration unit 40 periodically derives the integrated value ΥJb of heat energy in the four brake pads of the braking device 24 generated after the vehicle 1 has entered the drivable state, and supplies the derived integrated value ΥJb to the change unit 36. The heat energy includes heat energy generated by braking force controlled by the control unit 34 while the vehicle turns and heat energy generated by the braking force corresponding to the brake pedal depression amount. For example, the integration unit 40 periodically performs the following series of processing.

First, the integration unit 40 derives the heat energy Qin_i per unit time in the brake pads of each of the wheels 2 according to the following formula (1).

Qin_i=(μi·Aci·ri/Rdi)·Pci·Vwi[J/sec/wheel] Formula (1)

i is an integer from one to four. For example, i=1 indicates the value for the front left wheel 2fL. i=2 indicates the value for the front right wheel 2fR. i=3 indicates the value for the rear left wheel 2rL. i=4 indicates the value for the rear right wheel 2rR.

μi represents the friction coefficient of the brake pads of each of the wheels 2. Aci represents the cylinder area of each of the wheels 2. ri represents the effective braking radius of each of the wheels 2. Pci represents the cylinder pressure of each of the wheels 2. Rdi represents the tire dynamic loaded radius of each of the wheels 2. Vwi represents the wheel speed of each of the wheels 2.

Next, the integration unit 40 derives the sum of the heat energy Qin_i per unit time in the brake pads of each of the wheels 2 for four wheels, expressed by the following formula (2).

ΣQin_i i=1˜4[J/sec ] Formula (2)

Next, the integration unit 40 derives the sum to date of the product of the sum, calculated by formula (2), and the sampling time Δt as the integrated value σJb of the heat energy in the brake pads, as shown in the following formula (3).

τJb=Σ(σQin_i)Δt[J] Formula (3)

The friction coefficient i of the brake pads of each of the wheels 2 may be a constant value or may be a value that changes depending on the temperature of the brake fluid.

FIG. 4 shows the relationship between the friction coefficient of brake pads and the temperature of a brake fluid. The relationship shown in FIG. 4 is stored in advance in a storage unit (not shown), and the integration unit 40 may acquire the friction coefficient μi of brake pads determined according to this relationship and the detected temperature of the brake fluid. This makes it possible to derive the integrated value σJb of the heat energy more accurately.

The cylinder pressure Pci of each of the wheels 2 may be detected by a sensor not shown or may be estimated by a known method. The wheel speed Vwi of each of the wheels 2 may be detected by a sensor not shown or may be estimated by a known method.

When the ignition switch is turned from on to off, the timer unit 38 initializes the elapsed time to zero and the integration unit 40 initializes the integrated value σJb of the heat energy to zero.

The change unit 36 acquires the detected temperature Thf of the brake fluid. The change unit 36 determines that the braking device 24 is in the low-temperature state when the elapsed time Ts is equal to or smaller than the time threshold value Th1 and the temperature Thf of the brake fluid is equal to or lower than the temperature threshold value Th2 or when the elapsed time Ts is equal to or smaller than the time threshold value Th1 and the integrated value σJb of the heat energy is equal to or smaller than the integrated value threshold value Th3. It can also be said that the braking device 24 is in the low-temperature state is that the vehicle 1 including the braking device 24 is in the warming-up state.

The change unit 36 determines that the braking device 24 is in the non-low-temperature state when the elapsed time Ts is larger than the time threshold value Th1. The change unit 36 determines that the braking device 24 is in the non-low-temperature state also when the temperature Thf of the brake fluid is higher than the temperature threshold value Th2 and the integrated value σJb of the heat energy is larger than the integrated value threshold value Th3.

The time threshold value Th1, temperature threshold value Th2, and integrated value threshold value Th3 may be determined as appropriate through experiments or simulations.

In this way, it is possible to appropriately determine whether the braking device 24 is in the low-temperature state, based on the elapsed time Ts, temperature Thf of the brake fluid, and integrated value σJb of the heat energy.

The change unit 36 may also determine whether the braking device 24 is in the low-temperature state based further on the outside air temperature and the off time that is the time from the time the ignition switch is turned off to the time it is turned on.

For example, the change unit 36 may determine that the braking device 24 is in the low-temperature state when the outside air temperature is equal to or lower than the outside air temperature threshold value, the off time is equal to or larger than the off time threshold value, the elapsed time Ts is equal to or smaller than the time threshold value Th1, and the temperature Thf of the brake fluid is equal to or lower than the temperature threshold value Th2. The change unit 36 may determine that the braking device 24 is in the low-temperature state also when the outside air temperature is equal to or lower than the outside air temperature threshold value, the off time is equal to or larger than the off time threshold value, the elapsed time Ts is equal to or smaller than the time threshold value Th1, and the integrated value σJb of the heat energy is equal to or smaller than the integrated value threshold value Th3. The outside air temperature threshold value and the off time threshold value can be appropriately determined through experiments or simulations. This makes it easier to improve the accuracy of determining that the braking device 24 is in the low-temperature state.

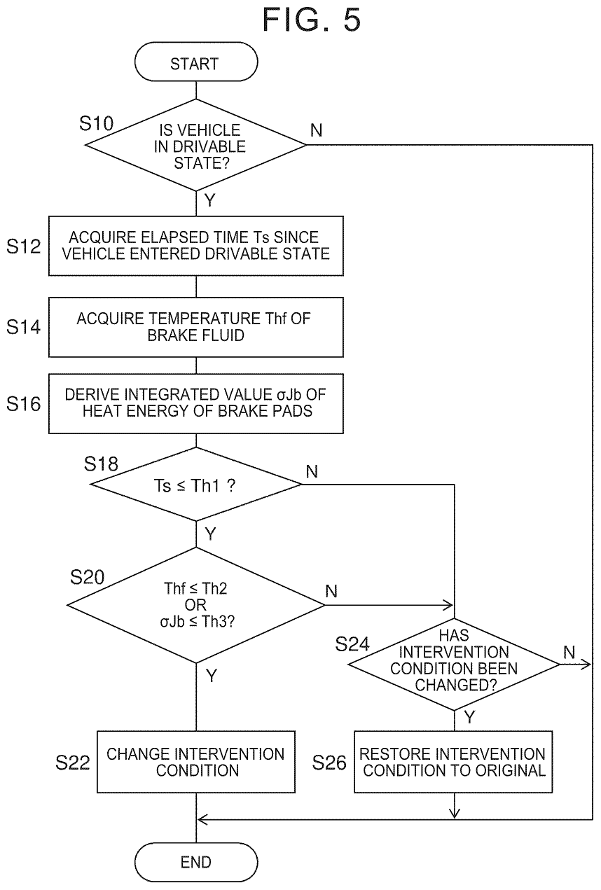

FIG. 5 is a flowchart showing the processing for changing the intervention condition of the braking control device 26 shown in FIG. 2. The processing in FIG. 5 is performed repeatedly.

When the vehicle 1 is not in the drivable state (N in S10), the braking control device 26 ends the processing. When the vehicle 1 is in the drivable state (Y in S10), the change unit 36 acquires the elapsed time Ts since the vehicle 1 entered the drivable state (S12) and the change unit 36 acquires the temperature Thf of the brake fluid (S14). The integration unit 40 derives the integrated value σJb of the heat energy of the brake pads (S16).

When the elapsed time Ts is equal to or smaller than the time threshold value Th1 (Y in S18), the change unit 36 changes the intervention condition (S22) when the temperature Thf of the brake fluid is equal to or lower than the temperature threshold value Th2 or when the integrated value σJb of the heat energy is equal to or smaller than the integrated value threshold value Th3 (Y in S20) and, then, the braking control device 26 ends the processing.

When the elapsed time Ts is larger than the time threshold value Th1 (N in S18) and the intervention condition has been changed (Y in S24), the change unit 36 restores the intervention condition to the original (S26) and the braking control device 26 ends the processing.

When the temperature Thf of the brake fluid is higher than the temperature threshold value Th2 and the integrated value σJb of the heat energy is larger than the integrated value threshold value Th3 (N in S20), the processing proceeds to S24. When it is determined in S24 that the intervention condition has not been changed (N in S24), the braking control device 26 ends the processing.

When the brake device 24 changes from the low temperature state to the non-low temperature state with the intervention condition satisfied, the change unit 36 may restore the changed condition, either the intervention condition or the intervention end condition whichever has been changed, to the original when the intervention end condition is satisfied. In other words, when the brake device 24 changes from the low temperature state to the non-low-temperature state with the intervention condition satisfied, the change unit 36 does not need to restore the changed condition, either the intervention condition or the intervention end condition whichever has been changed, to the original until the intervention end condition is satisfied. In this case, the condition can be restored to the original after the end of the braking control intervention. This makes it less likely that the occupant will feel uncomfortable.

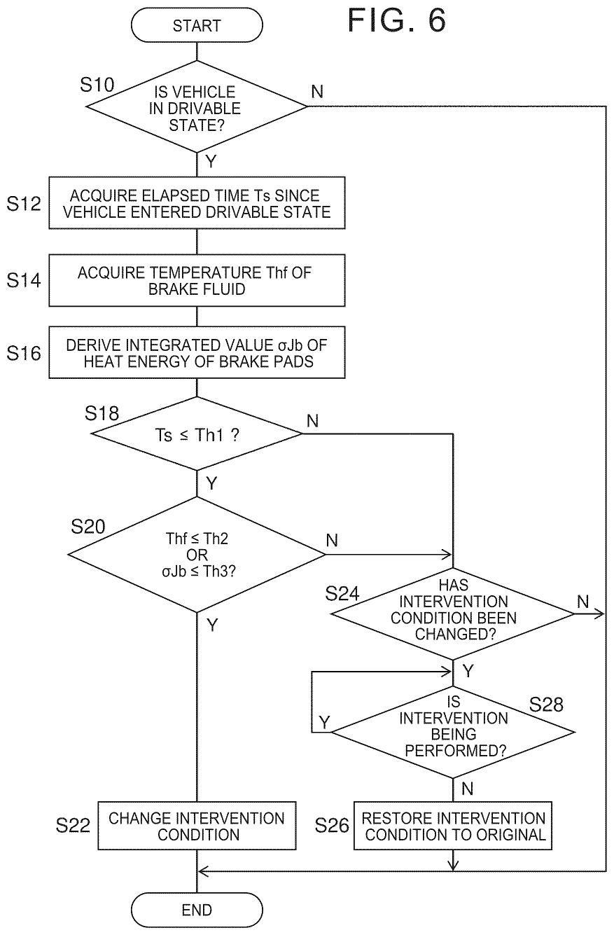

FIG. 6 is a flowchart showing another processing for changing the intervention condition of the braking control device 26 shown in FIG. 2. The processing in FIG. 6 is performed repeatedly. The processing from S10 to S24 is the same as the processing from S10 to S24 in FIG. 5.

When it is determined in S24 that the intervention condition has been changed (Y in S24), the change unit 36 determines whether braking control intervention is being performed (S28). When intervention is being performed (Y in S28), the change unit 36 returns processing to the processing in S28. When intervention is not being performed (N in S28), the change unit 36 restores the intervention condition to the original (S26), and the braking control device 26 ends the processing.

The present disclosure has been described above based on the embodiment. The embodiment is merely an example, and it is understood by those skilled in the art that various modifications are possible in the combination of components and processing steps and that such modifications are also within the scope of the present disclosure.

What is claimed is:

1. A braking control device comprising:
a control unit configured to control a yaw moment and a roll moment by independently controlling a braking force to be applied to each of wheels of a vehicle by a braking device from a time an intervention condition is satisfied to a time an intervention end condition is satisfied while the vehicle turns; and
a change unit configured to perform at least one of changing the intervention condition to be more easily satisfied and changing the intervention end condition to be less easily satisfied when the braking device is in a low-temperature state than when the braking device is in a non-low-temperature state.

2. The braking control device according to claim 1, wherein, when the braking device changes from the low-temperature state to the non-low-temperature state, the change unit is configured to restore the changed condition, either the intervention condition or the intervention end condition which has been changed, to an original.

3. The braking control device according to claim 1, wherein, when the braking device changes from the low-temperature state to the non-low-temperature state, the change unit is configured to restore the changed condition, either the intervention condition or the intervention end condition whichever has been changed, to an original when the intervention end condition is satisfied.

4. The braking control device according to claim 1, wherein:
the intervention condition includes that a steering angular speed is equal to or higher than a first angular speed threshold value;
changing the intervention condition to be more easily satisfied includes changing the first angular speed threshold value to a smaller value;
the intervention end condition includes that the steering angular speed is lower than a second angular speed threshold value or that an elapsed time since the intervention condition was satisfied reaches an end time, the second angular speed threshold value being smaller than the first angular speed threshold value; and
changing the intervention end condition to be less easily satisfied includes at least one of changing the second angular speed threshold value to a smaller value and changing the end time to a larger value.

5. The braking control device according to claim 1, wherein the change unit is configured to determine whether the braking device is in the low-temperature state based on an elapsed time since the vehicle became drivable, a temperature of a brake fluid of the braking device, and an integrated value of heat energy in brake pads of the braking device since the vehicle became drivable.
